(19) United States
(12) Patent Application Publication
(10) Pub. No.: US 2005/0069226 A1
(43) Pub. Date: Mar. 31, 2005

(54) Method for providing a sheet of film for digital image data records in medical imaging

(76) Inventors: Thomas Birkhoelzer, Radolfzell (DE); Frank Krickhahn, Herzogenaurach (DE); Juergen Vaupel, Weisendorf (DE)

Correspondence Address: HARNESS, DICKEY & PIERCE, P.L.C., P.O.BOX 8910, RESTON, VA, 20195, US

(21) Appl. No.: 10/948,289

(22) Filed: Sep. 24, 2004

(30) Foreign Application Priority Data
Sep. 26, 2003 (DE) 10344809.8

(51) Int. Cl. G01N 23/00; G01T 1/00; G06F 17/60; G01N 23/04; G06K 9/54; G06K 9/60

(52) U.S. Cl. 382/305; 378/1; 378/62

(57) ABSTRACT

A method is for providing a sheet of film for digital image data records in medical imaging which are captured in a medical data acquisition center. An external service provider receives the digital image data records from the medical data acquisition center via a network. An exposure device is then used to prepare a sheet of film from the digital image data records. Finally, the sheet of film is sent to an addressee. As such, both the economic involvement and the time involvement of the medical data acquisition centers, for providing sheets of film from their digital image data records, is reduced.

The present application hereby claims priority under 35 U.S.C. §119 on German patent application number DE 103 44 809.8 filed Sep. 26, 2003, the entire contents of each of which are hereby incorporated herein by reference.

### FIELD OF THE INVENTION

The present invention generally relates to a method for providing a sheet of film, particularly an X-ray film, for digital image data records in medical imaging which are captured in a medical data acquisition center.

### BACKGROUND OF THE INVENTION

In medical imaging, physical regularities are exploited to obtain images of the inside of the body of a living examination object. The image data records for the images are captured in a medical data acquisition center, for example in the radiology department of a hospital, using the appropriate device and are visually displayed, i.e. are shown on an appropriate display unit, after conditioning or evaluation of the raw or image data obtained during the measurement.

Images are normally produced, calculated and stored in digital form, for example in digital radiography, computer tomography, magnetic resonance tomography or nuclear medicine. However, even in this entirely digital environment of medical imaging, it is still necessary to produce sheets of film, particularly X-ray films, for many instances of use. This is necessary, by way of example, when the captured images are being sent to a doctor who does not support digital findings.

For this purpose and also for archiving purposes, data acquisition centers have an exposure device which can produce X-ray films from the digital image data records when required. Such an exposure device, for example in the form of a laser scanner, is relatively expensive, however. Since digital data processing is progressing to an ever increasing extent in the medical sector too, many data acquisition centers are finding it increasingly uneconomical to purchase and maintain an exposure device.

### SUMMARY OF THE INVENTION

An object of an embodiment of the present invention is to provide a method for providing sheets of film for digital image data records in medical imaging which reduces the involvement for preparing the sheets of film for the medical data acquisition center both in terms of time and in terms of economics.

In one embodiment, the present method is for providing a sheet of film from digital image data records in medical imaging which are captured in a medical data acquisition center. An external service provider receives the digital image data records from the medical data acquisition center via a network, uses an appropriate exposure device to prepare a sheet of film from the digital image data records (filming), and sends this sheet of film to the medical data acquisition center or to one or more addressees specified thereby.

In the case of the present method, the external service provider (an “application service provider”) is economically independent in his actions and is independent of the data acquisition center organizationally. In the embodiments of the present patent application, medical data acquisition center is naturally to be understood to mean not just the radiology department of a hospital. Rather, this term covers all medical centers in which medical imaging is performed. These may be individual radiology practices or else cardiology or other specialist medical fields, for example.

When using the present method in at least one embodiment, the involvement for the medical data acquisition center is low, since no kind of exposure device needs to be kept at the ready and also no corresponding operating time is required for preparing the sheet of film. Rather, the medical image data records available in digital form are transferred via a network to the external service provider, which prepares the corresponding sheets of film. The service provider then sends these sheets of film directly to an appropriate addressee, for example a referring doctor, if appropriate.

As a result of the introduction of the DICOM standard in medical imaging, the digital image data records to be sent are normally available in DICOM format and are preferably also transferred observing the DICOM standard via the network. DICOM (Digital Imaging and Communications in Medicine) is a specific standard for radiology which applies throughout the world. It was designed on the basis of the OSI model (Open System Interconnection Model), which permits communication between heterogeneous systems. It can be used to interchange images and data from different imaging and image-processing devices between these devices. DICOM standardizes the structure of the formats and descriptive parameters for radiological images and commands for interchanging these images, and also the description of other data objects, such as image sequences, series of examinations and findings.

In one advantageous embodiment of the present method, the external service provider's server therefore has a DICOM interface, so that it can be reached from a workstation in the data acquisition center via a DICOM node. The digital image data records, which are normally available in DICOM format, are therefore sent to the external service provider very easily.

The digital image data records can be transferred using either a publicly accessible network, such as the Internet, or closed networks. Similarly, a “dial-in point-to-point” connection can be used for safe transfer. When transferring the data records via the Internet, for example using the http protocol or via e-mail, encrypted transfer protocols such as SSL are preferably used. For transfer via the Internet, the service provider preferably has a web page which can be used to contact it and to set up the appropriate encrypted connection.

The services of the service provider may be paid for, by way of example, per sheet of film or else in the form of a subscription or as part of a service agreement at fixed intervals of time regardless of the number of sheets of film prepared. In addition, it goes without saying that the services of the service provider may also be provided at no cost when advertisements are inserted accordingly. A hybrid form of the models cited is also possible. Invoices may also be sent directly to the specified addressee.

### BRIEF DESCRIPTION OF THE DRAWINGS

The present invention will become more fully understood from the detailed description of the exemplary embodiments given hereinbelow and the accompanying drawings, which are given by way of illustration only and thus are not limitative of the present invention, and wherein:

FIG. 1 shows an exemplary embodiment.

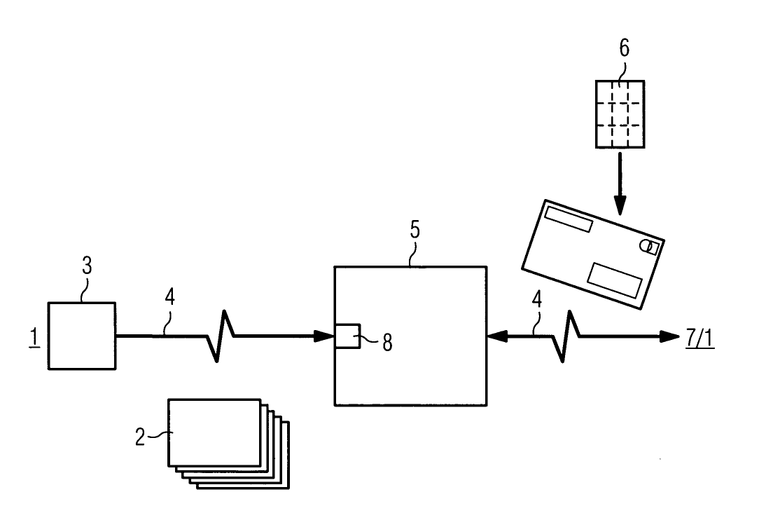

### DETAILED DESCRIPTION OF THE EXEMPLARY EMBODIMENTS

The present method is explained again briefly below using an exemplary embodiment in conjunction with the figure.

In this exemplary embodiment, digital image data from a patient are captured in a medical data acquisition center 1, for example the radiology unit in a hospital. The digital image data records 2 are available in DICOM format.

These image data records 2 are then sent to the server of the external service provider 5 using a data station 3 in a medical data acquisition center 1 via a network 4 by way of the Internet or DICOM. They can be sent via the Internet using a standard network protocol, for example TCP/IP.

The external service provider 5 produces an X-ray film 6 from these digital image data 2 and sends it to the service receiver 7. This service receiver may either be the medical data acquisition center 1 which produced the digital image data records 2 or an addressee 7 which the data acquisition center specifies, for example the doctor who referred the patient to the radiology unit. In this context, the X-ray film 6 is sent by mail or by courier. The X-ray film 6 itself is prepared by the external service provider 5 in a known manner using a suitable exposure device, particularly a laser scanner.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for providing a sheet of film for digital image data records in medical imaging, comprising:
receiving the digital image data records from a medical data acquisition center via a network;
using an exposure device to prepare a sheet of film from the digital image data records; and
sending the sheet of film to an addressee.

2. The method as claimed in claim 1, wherein a DICOM interface is used to receive the image data records.

3. The method as claimed in claim 1, wherein the digital image data records are transferred via a publicly accessible network.

4. The method as claimed in claim 3, wherein the digital image data records are transferred using a standard protocol.

5. The method of claim 1, wherein the digital image data records are captured in a medical data acquisition center.

6. The method of claim 1, wherein the digital image data records are received by an external service provider.

7. The method of claim 5, wherein the digital image data records are received by an external service provider.

8. The method as claimed in claim 6, wherein a DICOM interface is used to receive the image data records.

9. The method as claimed in claim 7, wherein a DICOM interface is used to receive the image data records.

10. The method as claimed in claim 3, wherein the digital image data records are transferred via the Internet.

11. A method, comprising:
receiving, via a network, digital image data records obtained by medical imaging;
preparing a sheet of film from the digital image data records; and
sending the sheet of film.

12. The method as claimed in claim 11, wherein a DICOM interface is used to receive the image data records.

13. The method as claimed in claim 11, wherein the digital image data records are received and sent via a publicly accessible network.

14. The method as claimed in claim 13, wherein the digital image data records are received and sent using a standard protocol.

15. The method of claim 11, wherein the digital image data records are captured in a medical data acquisition center.

16. The method of claim 11, wherein the digital image data records are received by an external service provider.

17. The method as claimed in claim 16, wherein a DICOM interface is used to receive the image data records.

18. The method as claimed in claim 13, wherein the digital image data records are transferred via the Internet.

19. An apparatus, comprising:
means for receiving, via a network, digital image data records obtained by medical imaging;
means for preparing a sheet of film from the digital image data records; and
means for sending the sheet of film.
